(19) United States
(12) Patent Application Publication
(10) Pub. No.: US 2004/0247421 A1
(43) Pub. Date: Dec. 9, 2004

(54) Pick-to-light system

(76) Inventors: Leland N. Saunders, Kentwood, MI (US); George J. Zeeff, Grand Rapids, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/796,816

(22) Filed: Mar. 9, 2004

Related U.S. Application Data
(60) Provisional application No. 60/456,753, filed on Mar. 20, 2003.

(51) Int. Cl. B65G 1/00

(52) U.S. Cl. 414/500

(57) ABSTRACT

A method of picking products in a pick-to-light system includes arranging products in first and second rows of adjacent picking locations wherein the products are available for picking. Groups of totes are aligned with the picking locations where products to be picked are matched up with the applicable totes. When indicated, products are picked and placed in the indicated totes. When the indicated products are picked for each indicated tote in a given group of totes and the picks are complete for the upstream totes in a given row of picking locations, the group of totes in the given row are indexed so that the totes align with other picking locations in the given row.

This application incorporates by reference herein in its entirety pending U.S. provisional application entitled PICK-TO-LIGHT SYSTEM, filed Mar. 20, 2003, Ser. No. 60/456,753.

### TECHNICAL FIELD AND BACKGROUND OF THE INVENTION

The present invention relates to an induction system and, more particularly, to a picking system that permits filling of a large quantity of orders of different products.

Conventional pick-to-light systems organize products to be picked in rows and columns, with the products supported in boxes or containers, for example, in flow racks. Pickers or operators are prompted by lights (hence the name pick-to-light), which are illuminated one at a time to indicate which product is to be picked. In response to the light, the operators pick and place a product in a tote that is supported in front of the flow rack. When the product is picked, the operator presses a button to indicate that the pick is complete. Another light will then be activated to indicate when another product in that picking location is to be picked. The totes are typically supported on a roller conveyor so that when a pick is complete for a flow rack the operator can move the tote to the next flow rack. After the pick is complete for a given flow rack and the tote has been moved down to the next flow rack, the process will be repeated for the next tote. In some systems, the operator must scan each tote when it is moved in front of a flow rack so that the system will associate an order with that particular tote. In other systems, the system relies on the totes being in sequence to determine the order for a particular tote.

More recently, some pick-to-light systems have operators manually pick and place the products onto conveyors, which deliver the products to, for example, totes, which are collected and transported for delivery. Again, the flow racks holding products are typically arranged in rows or aisles, with operators assigned to a group of flow racks in a particular zone along the row or aisle. The operators are prompted by lights, which are illuminated one at a time to indicate when a product is to be picked. When the product is picked, the operator presses a button to indicate that the pick is complete.

In each system, only when all the products in all the picking zones in an aisle are picked, will the picking system then initiate the next order. Hence it has been found that there are periods when the operators are not picking because a downstream operator has not completed his or her pick for their assigned picking zone. As a result, operators often cannot work at their optimum level and have downtimes when no articles are being picked. Therefore, slower pickers tend to dictate the pick rate for all the pickers in an aisle. Accordingly, the current picking systems result in the overall order fulfillment process being slower and less efficient than desired.

Consequently, there is a need for a picking system for products that can permit pickers to work at their full capacity to reduce the inefficiencies of the pick-to-light systems heretofore known.

### SUMMARY OF THE INVENTION

Accordingly, the picking system of the present invention is configured to permit pickers to work in parallel so that they can work at their full capacity to thereby increase the through-put of the pick-to-light systems.

In one form of the invention, a method of picking products in a pick-to-light system includes arranging products in first and second rows of adjacent picking locations wherein the products are available for picking, aligning groups of totes with the picking locations, and indicating a given tote in the group of totes. The indicated products are then picked and placed in the given tote. After the indicated products are picked for each given tote in a first group of totes, the first group of totes is indexed from the first picking location to the second picking location while a second group of totes is indexed to the first picking location.

In one aspect, the groups of totes are supported on conveyors. The conveyor supporting the first group of totes is automatically driven to index the first group of totes.

In another aspect, the products are arranged on flow racks, with each flow rack having a product induct side and a product discharge side. The product discharge sides define the picking locations wherein the products flow from the induct sides of the flow racks to the discharge sides to the picking locations.

According to other aspects, lights at each of the picking locations associated with each type of product are provided and actuated to indicate when a product is to be picked for a given tote. In another aspect, a designated light is provided at each of the picking locations for each type of product, which is actuated when a product is to be picked for the given tote.

In yet other aspects, each tote includes an identifier associated with it, such as a name or a bar code or an indicator, such as a light, which, for example, could be mounted to the conveyor. In preferred form, a group of at least two totes, preferably two to four totes, are aligned with a respective picking location. In this manner, groups of totes are indexed when the identified products have been picked and placed in the applicable tote or totes of the group of totes.

According to another form of the invention, a method of picking products in a pick-to-light system includes providing products in a first row of picking bays, providing products in a second row of picking bays spaced from the first row of picking bays, and forming an aisle between the discharge sides of the first and second rows of picking bays. Access is provided across the aisle so that an operator may move between the discharge sides of the first and second rows of picking bays. A first group of totes is aligned with the discharge side of a respective picking bay in the first row. A second group of totes is aligned with the discharge side of a respective picking bay in the second row. One or more products in the respective picking bay of the first row is indicated for picking by the operator for a tote in the first group of totes. Similarly, one or more products in the respective picking bay of the second row is indicated for picking by the operator for a tote in the second group of totes. When the indicated product or products have been picked and placed in the totes of a respective group of totes by the operator, the respective group of totes is indexed to the next picking bay wherein the operator may continue to pick at another picking bay.

In one aspect, the respective picking bay of the first row is the first picking bay of the first row. Similarly, the respective picking bay of the second row may be the first picking bay of the second row.

In further aspects, a product or products in the next picking bay is indicated for picking by the operator for the respective group of totes after the respective group of totes is indexed to the next picking bay. Also, one or more products may be indicated for picking by an operator at the previous picking bay of the respective row for a third group of totes. In addition, when the pick is complete for both the respective group of totes and the third group of totes, the respective group of totes and the third group of totes are indexed wherein the respective group of totes aligns with a discharge side of another picking bay of the respective row and the third group of totes aligns with the discharge side of the another picking bay of the respective row.

In other aspects, the totes are supported on first and second conveyors adjacent the discharge sides of the picking bays of the first and second rows of picking bays, respectively. The conveyors are automatically driven to index the totes.

According to yet other aspects, the products are supported on flow racks, with the products flowing from the induct sides to the discharge sides of the racks.

In another aspect, a control system is provided that controls the lights and detects when an indicated product has been picked for a given tote. Preferably, the control system controls the movement of the conveyors, which index group groups of totes to the next picking bays when the picks are complete at the previous picking bays.

For example, the control system may include an actuator, with the control system detecting when the actuator has been actuated to detect when an indicated product has been picked for a given tote.

In another form of the invention, a pick-to-light system includes means for supporting products in first and second rows and for grouping the products in a plurality of picking locations, means for aligning a first group of totes adjacent a respective picking location in the first row, means for aligning a second group of totes adjacent a respective picking location in the second row, and means for identifying each tote within the group of totes. The system also includes means for indicating which products are to be picked and placed in a given tote of the group of totes at the respective picking locations, and means for indexing the groups of totes from the respective picking locations. The system also includes a control for actuating the means for indexing when the products for a respective picking location are picked.

In one aspect, the means for supporting comprises a plurality of racks. For example, the racks may comprise flow racks, with each rack having an induct side and discharge side. Further, the means for aligning is adjacent the discharge sides of the flow racks.

In other aspects, the means for aligning the first group of the totes and the means for aligning the second group of totes comprise first and second conveyors, respectively.

According to other aspects, the means for indexing comprises automatically driven conveyors.

According to yet another form of the invention, a pick-to-light system includes a plurality of racks, which support groups of products in first and second rows of adjacent picking locations, a plurality of totes, and first and second conveyors. The first conveyor supports a first group of the totes adjacent a respective picking location of the first row. The second conveyor supports a second group of the totes adjacent a respective picking location of the second row. The system further includes a control system for identifying selected products to be picked for a given tote and detecting when the selected products are picked for the given tote. Furthermore, the control system actuates the first conveyor to index the first groups of totes to the another picking location in the first row when the selected products of the previous picking location in the first row have been picked and placed in the respective tote or totes of the first groups of totes and actuates the second conveyor to index the second groups of totes to the next picking location in the second row when the selected products of the previous picking location in the second row have been picked and placed in the respective tote or totes of the second group of totes.

In one aspect, the control system includes indicators, which identify the selected products to be picked. For example, the indicators may include lights for identifying the selected products to be picked. Furthermore, the indicators may include displays for identifying a given tote. Preferably, each of the totes includes an identifier, which can be displayed by the displays of the indicators. Alternately, each picking location may include an indicator, which for example, may be mounted to the conveyor, for each respective tote, which indicates when a given tote is to be filled with a picked product. For example, the indicator may be a light that is actuated when the tote is to be filled.

In another aspect, each of the totes includes an identifier, which is readable by the control system, such as a bar code.

In one form of the invention, a method of picking products in a pick-to-light system includes arranging products in first and second rows of adjacent picking locations wherein the products are available for picking, aligning totes with the picking locations, and identifying at least one of the totes. The indicated products are then picked and placed in the identified tote. After the indicated products are picked for each identified tote in a respective row, the totes in that row are automatically indexed from their respective picking locations to their next picking locations or conveyed away.

In one aspect, the totes are supported on conveyors. The conveyors supporting the totes are selectively driven to index the totes.

In another aspect, the products are arranged on flow racks, with each flow rack having a product induct side and a product discharge side. The product discharge sides define the picking locations wherein the products flow from the induct sides of the flow racks to the discharge sides to the picking locations.

According to other aspects, lights at each of the picking locations associated with each type of product are provided and actuated to indicate when a product is to be picked for an identified tote. In another aspect, a designated light is provided at each of the picking locations for each type of product, which is actuated when a product is to be picked for the identified tote.

In yet other aspects, each tote includes an identifier, such as a name or a bar code, which is displayed to identify the tote. In preferred form, at least two totes are aligned at each respective picking location. In this manner, groups of totes are indexed when the identified products have been picked and placed in each identified tote of the group of totes.

It can be appreciated from the foregoing, therefore, that the present pick-to-light system can increase the picking time for each operator to thereby enhance the throughput and efficiency of the pick-to-light system.

These and other objects, advantages, purposes, and features of the invention will become more apparent from the study of the following description taken in conjunction with the drawings.

### BRIEF DESCRIPTION OF THE DRAWINGS

FIG. 1 is a plan view of a pick-to-light system of the present invention;

FIG. 2 is an enlarged partial view of the induct end of the pick-to-light system of FIG. 1;

FIG. 3 is an enlarged partial plan view of the discharge end of the pick-to-light system of the present invention;

FIG. 4 is a further enlarged partial plan view of the induct end of the pick-to-light system of FIG. 2;

FIG. 5 is a further enlarged partial plan view of the discharge end of the pick-to-light system of the present invention;

FIG. 6 is a perspective view of a picking aisle with two rows of picking bays of the pick-to-light system of the present invention;

FIG. 7 is a perspective view of three picking bays of the pick-to-light system of the present invention;

FIG. 8 is an enlarged perspective view illustrating one picking bay of the pick-to-light system of FIGS. 1-5; and

FIGS. 9-16 illustrate an example of a picking sequence of the pick-to-light system of the present invention.

### DETAILED DESCRIPTION OF THE PREFERRED EMBODIMENTS

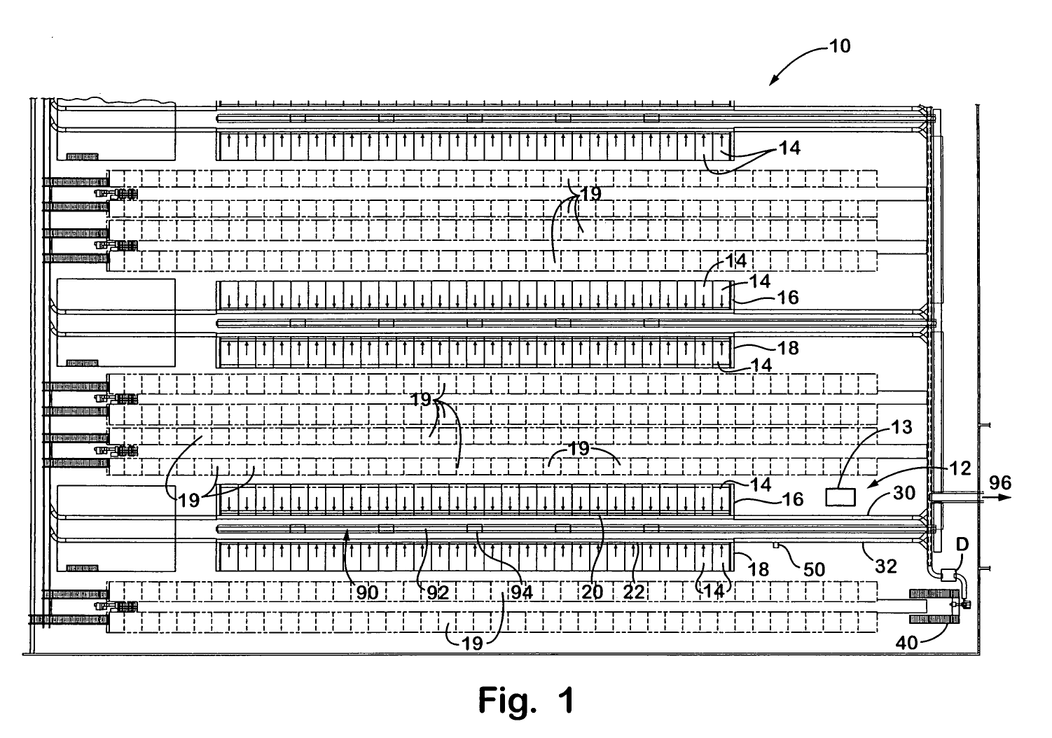

Referring to FIG. 1, the numeral 10 generally designates a pick-to-light system of the present invention. Pick-to-light system 10 includes a control system 12 which controls the operation of the pick-to-light system and, further, allows operators or pickers to continuously pick and to pick at a rate that is independent pf the picking rate of other operators—in other words, to pick in parallel rather than in series. Control system 12 includes a central controller 13 and a plurality of modules (70, 76 described in greater detail below) that permit communication between the operators of the pick-to-light system 10 and controller 13 and, further, that directs the operators to pick in a manner that permits an operator to increase his or her picking time so that the operators can work at his or her full capacity to thereby increase the throughput of the pick-to-light system, as will be more fully described below.

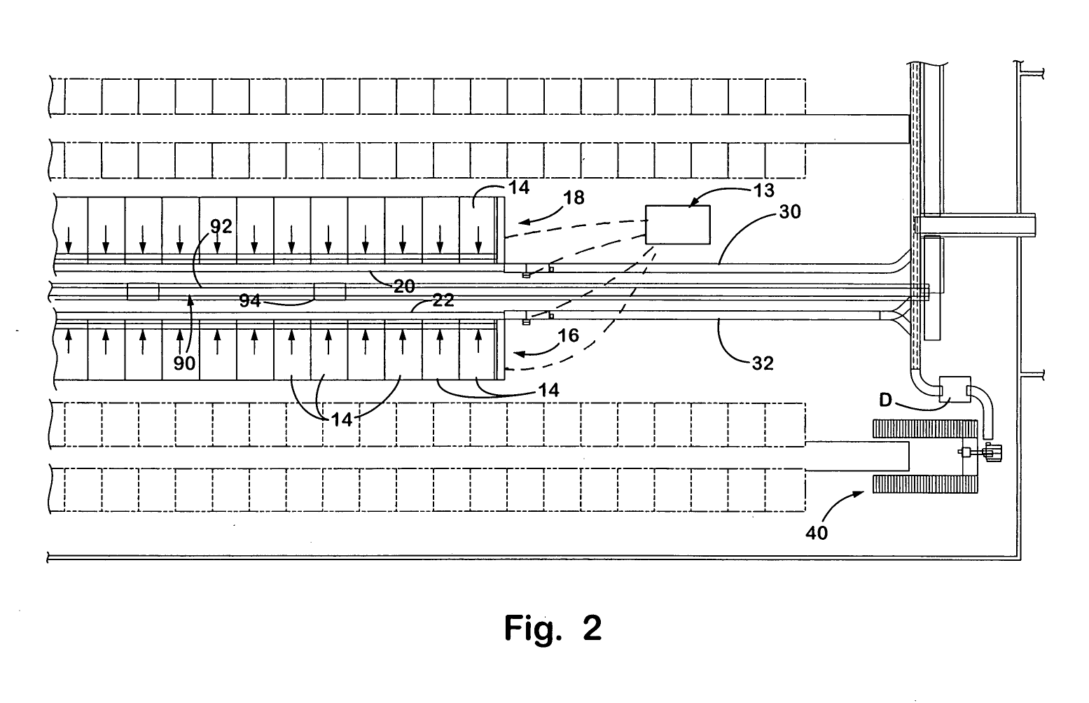

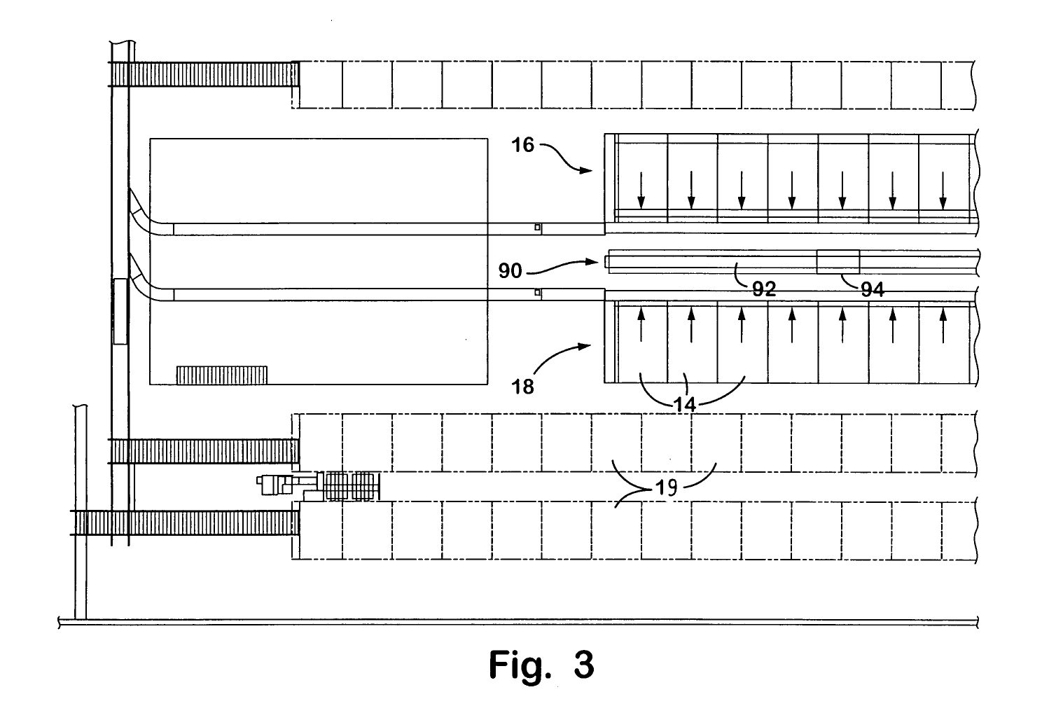

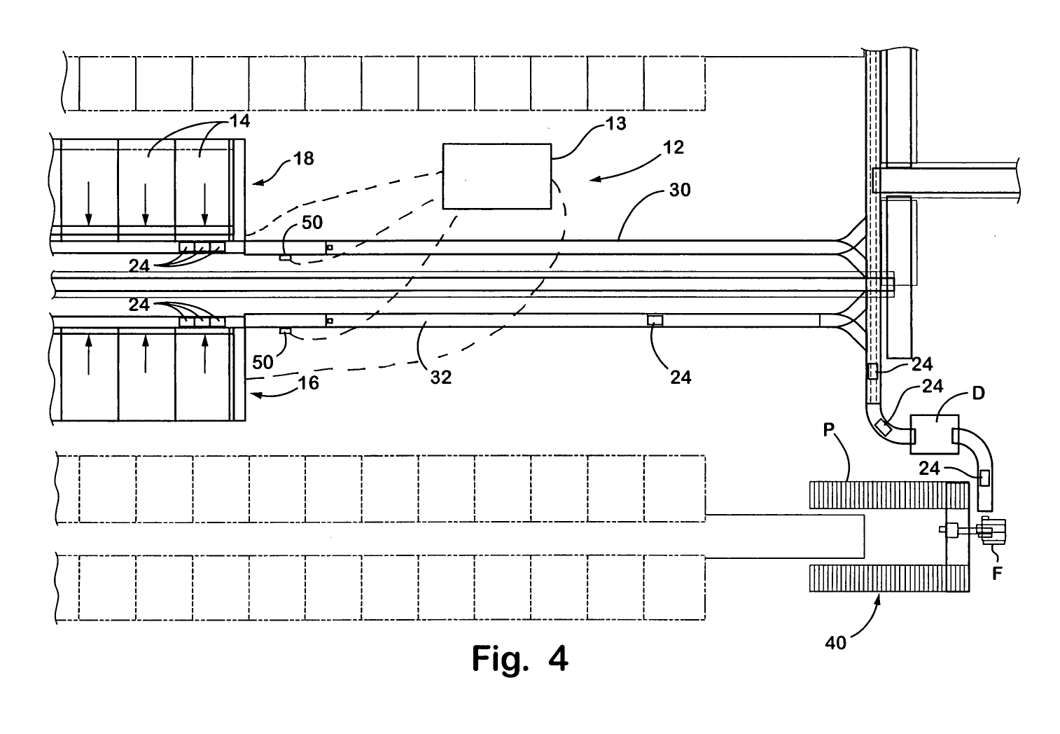

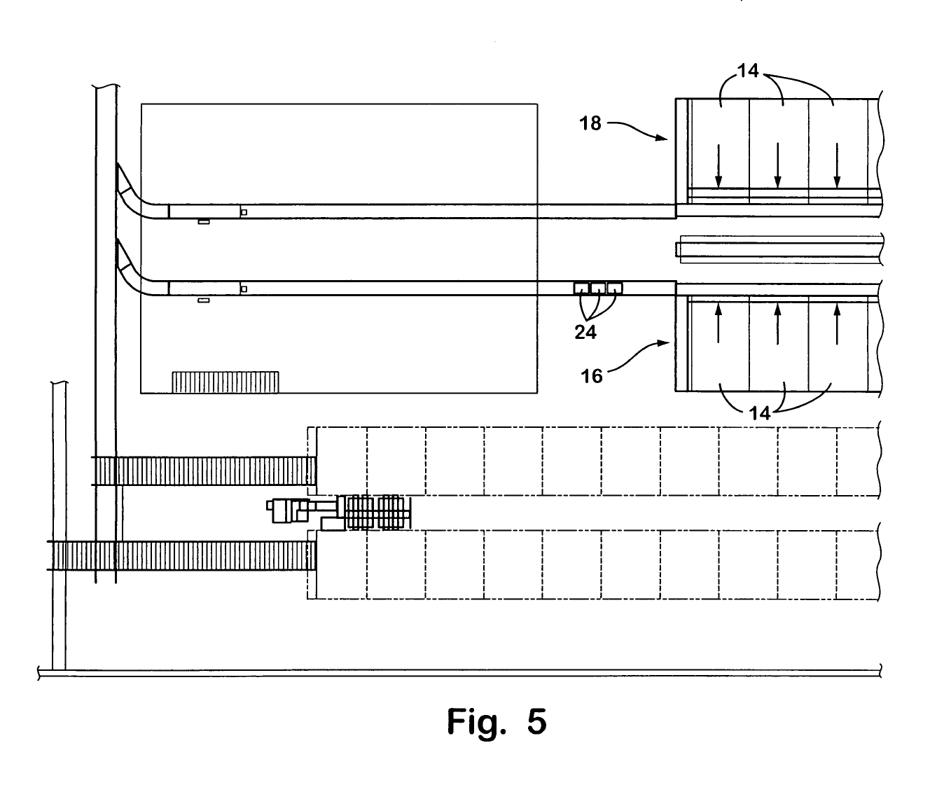

Referring to FIGS. 1-5, pick-to-light system 10 includes a plurality of picking bays 14 that are arranged in spaced apart rows 16 and 18 which define therebetween a picking aisle. Though reference hereinafter is made to two rows of picking bays and one aisle, it can be seen from FIG. 1 that a plurality of rows and aisle's are contemplated. The picking aisle preferably provides sufficient open space for operators to move between the picking bays so that the operators are not limited to a specific zone or specific set of picking bays, unlike the prior art systems.

Each bay 14 comprises a conventional case flow bay or rack, which includes a frame and a plurality of vertically spaced shelves that are supported by the frame and that include a plurality of rollers. Each shelf is canted or tilted so that products placed on the rollers forming the shelf will flow to one side of the shelf. The lower side of the shelves are typically aligned along a discharge side of the bay, while the higher side of the shelves are aligned along an induct side of the bay. Products are delivered by pallets and are placed on pallet racks 19, positioned behind the picking bays 14. The products are typically delivered in boxes, which are then opened by an operator and placed on the picking bay from the induct side of each picking bay.

In addition, pick-to-light system 10 includes conveyors 20 and 22 that are positioned adjacent the discharge sides of bays 14. Conveyors 20 and 22 convey and align totes 24 in front of or adjacent to the discharge sides of the bays of the respective row of bays to provide receptacles for the products of an order (or of a partial order). In addition, conveyors 20 and 22 are preferably selectively actuated by control system 12 to index the totes between the respective bays, as will be more fully described below. In this manner, the lower sides of the bays are adjacent a respective conveyor so that when a product is placed on a respective shelf of a bay, the product will, under the force of gravity, move toward the discharge side of the bay adjacent the respective conveyor where the product can be picked and placed into a designated tote. Typically, the products are stored in containers or boxes, which are delivered to the picking bays from the induct side of the bays, as noted above and as will be more fully described below.

In the illustrated embodiment, conveyors 20 and 22 comprise conventional driven belt conveyors, with the belts supported by rollers, as will be understood by those skilled in the art. It should be understood that other types of bays or conveyors may be used in the present application. In addition, conveyors 20 and 22 may comprise a plurality of conveyor sections, which are either individually driven or driven by a common driver, which driver or drivers are controlled by control system 12 so that the conveyors may be automatically driven or actuated to index the totes along the picking aisle adjacent the discharge sides of the respective picking bays.

Totes 24 are conventional plastic totes and are delivered to conveyors 20 and 22 by roller conveyors 30 and 32. Optionally, totes 24 may be delivered to the pick-to-light system area in stacks, which may be handled using pallets. For example, the pallets P may be conveyed on a pallet conveyor to tote handling area 40. The totes can be taken off or removed from the pallets, for example, by a lift mechanism F, such as a robot. Tote handling area 40 may include a de-stacker D, which automatically singulates the totes and delivers to totes to conveyors 30 and 32, which deliver the totes to the respective conveyors (20 and 22) of the respective row of picking bays.

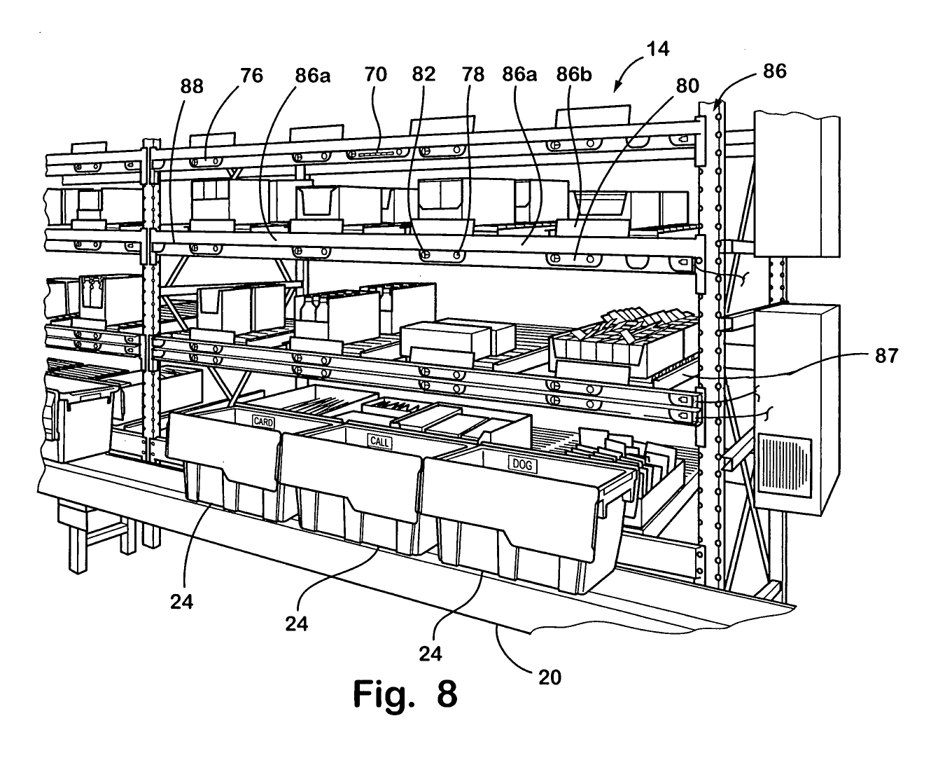

In preferred form, each tote 24 includes an identification, such as an identification label with a barcode, which is read by control system 12 and is associated by control system 12 with an order. Alternately, the totes may be identified by an indicator, such as a light, that is mounted independently of the tote, such as mounted to the conveyor. In the case of the totes with individual identification labels, when the totes are delivered to the conveyors 20 and 22 by roller conveyors 30 and 32, the identification on the respective totes is read, for example by optical readers 50, which are positioned adjacent roller conveyors 30 and 32 and are also in communication with controller 13. In operation, initially a first group of totes are transferred from roller conveyors 30 and 32 and placed on conveyors 20 and 22. When the control system is initialized, control system 12 indexes the totes to a first picking bay, which may comprise the first picking bay in the row or a downstream picking bay. For example, the first group of totes may be indexed to a downstream picking bay where the upstream picking bay or bays do not have products for any of the totes in the first group of totes. Control system 12 then directs operators to remove a designated product or products from a picking bay and to place it into a designated tote of the group of totes. While each tote is uniquely identified and identifiable to control system 12 by, for example, the identification label, the totes are also preferably marked with an identifier that is identifiable to the operator and, further, is encoded, for example, into the identification label read by control system 12. For example, referring to FIG. 8, each tote of the group of totes may be identified by a name or other identifier or indicator, with the control system directing the operator to remove product from the picking bay to place into a designated tote of the group of totes, as will be more fully explained below.

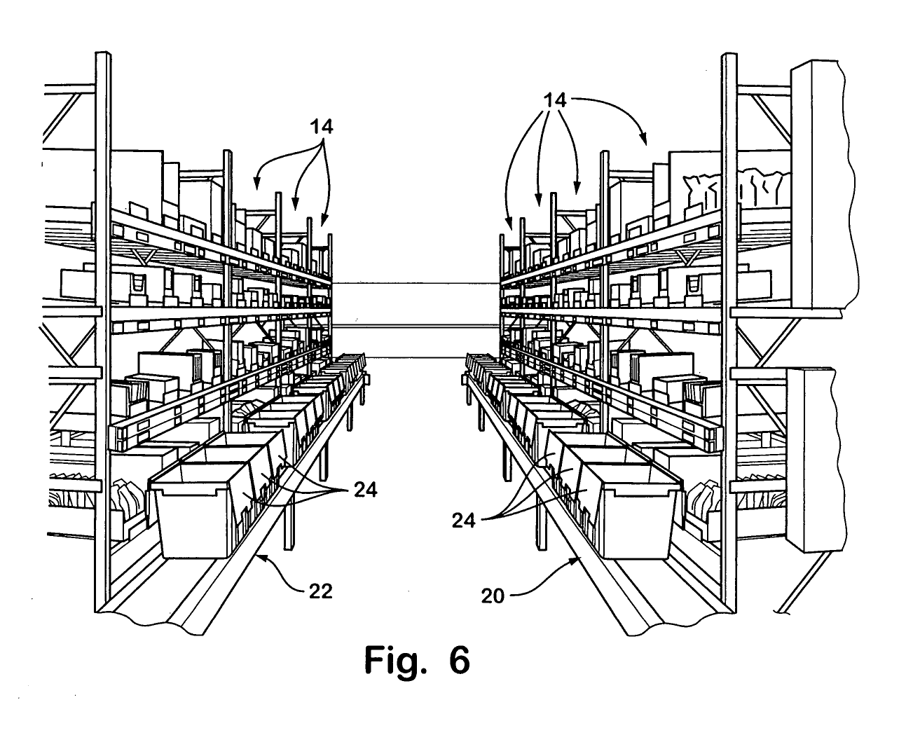

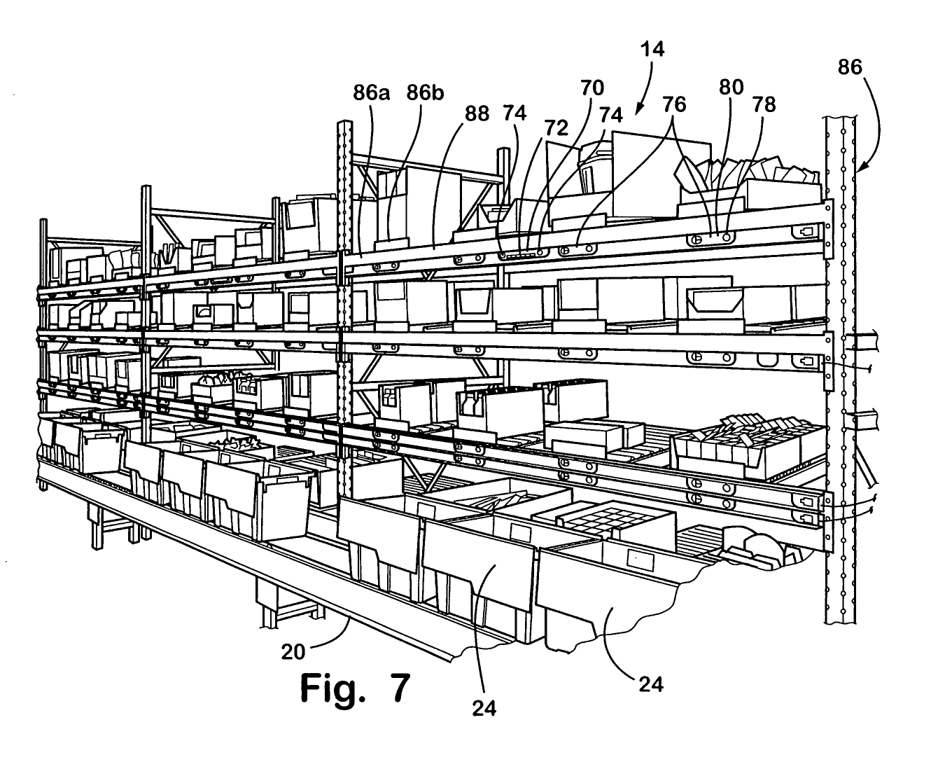

As best seen in FIGS. 6-8, each picking bay 14 includes a bay display module 70 (FIG. 7), which includes a display 72 and one or more buttons 74 to permit communication between the operator and control system 12. Display 72 displays the identification, such as the name, of the tote to be filled with the product. To designate a specific product, each picking bay includes a pick module 76 associated with each group of products. Products are arranged in rows that extend across a respective shelf from the induct side to the discharge side of the bay. Each pick module 76 includes at least one light 78 that is actuated by control system 12 to designate that a product associated with the pick module must be picked from that particular row of products and placed into the tote identified by bay display module 70. In the case of the totes being identified by an indicator that is mounted independently of the tote and, instead, mounted to the conveyor, then when light 78 is actuated a product associated with that pick module is picked and placed into the tote identified by the indicator. Optionally, each pick module 76 may include a display 80 to display the number of the particular product that needs to be placed into the designated tote.

In order to signal to controller 13 of control system 12 that a pick is complete, pick module 76 includes one or more buttons 82 that permit the operator to indicate when the order fulfillment for that particular product has been complete for the designated tote. Once all the picks have been completed for each tote in the group of totes for a particular picking bay 14, control system 12 actuates the respective conveyor to index the group of totes to the next picking bay provided the orders for the downstream totes have also been completed at their respective picking bays. Should the downstream totes not have their pick completed, the operator may move to another bay in the same row or to the other side of the picking aisle to pick from the other picking bay in the other row. In this manner, operators may move between the respective picking bays on either side of the picking aisle, which enables operators to continue picking and, therefore, maximize the throughput of the pick-to-light system. After the order has been fulfilled for a group of totes and the totes have been indexed from the last picking bay, the totes are conveyed to a take-away conveyor, which takes the totes to the shipping area.

As noted above, each picking bay 14 includes a frame 80 and a plurality of spaced shelves 87. In the illustrated embodiment, the column members of the frames may be shared by adjacent picking bays; though it should be understood that each picking bay may be a free standing structure or the like. Shelves 87 are supported on the frame by transverse frame members 86a. To stop the flow of products off the shelves, the transverse frame members include stops 86b, such as angle members, which are releasably mounted to the transverse members by fasteners and are aligned with the respective rows or products that extend across the shelves from the induct side to the discharge side of the respective shelf. In addition, mounted to the front of the transverse members are power channels 88 to which pick modules 76 and bay modules 70 are mounted.

Each power channel 88 comprises a channel member with elongate grooves that extend along the channel member. Insulated low voltage wiring extends along each of the grooves, with the wiring preferably captured in the grooves. The wiring is in communication with controller 13 of control system 12 to provide power to and communication with modules 70 and 76. Each bay module 70 and pick module 76 includes circuitry to power and provide communication to the respective displays and buttons provided on the modules, which are preferably mounted on a circuit board for ease of assembly. Each module further includes leads coupled to the module circuitry, which are adapted to be inserted into the insulated low voltage wiring to thereby couple the respective modules to controller 13 of control system 12. Furthermore, the leads are adapted to permit the respective modules to be unplugged from the insulated wire and reinserted in the insulated wire at another location so that the modules can be relocated along the power channels. For example, leads may comprise prongs that are sufficiently pointed to pierce the insulation on the wires so that the leads directly contact the wires to thereby electrically couple the modules to control system 12.

As would be understood from the foregoing description, pick modules 76 and bay display modules 70 therefore permit communication between the operators and controller 13 of control system 12. As noted above, modules 70 and 76 allow an operator to communicate that a pick is complete for a particular tote or group of totes. In addition, either module 70, 76 may include function buttons that allow the operator to indicate other status information. For example, if an operator determines that the picking bay is short on a product, the operator can signal the controller using the function key or keys.

Furthermore, controller 13 may include one or more modes of operation. For example, controller 13 may be configured for use as an inventory system. In preferred form, bay module 70 may then display the mode of operation—that is bay module 70 may display PICK when in a pick mode or SCAN when in an inventory mode or the like. When the system is in an inventory mode, operators go to the respective picking bays and count the products associated with the respective pick module and input the inventory count into the pick module using the buttons on the pick module, which then transfers the inventory information to controller 13 of control system 12. When the count is complete, the operator will press the enter button or complete button, for example. As noted above, the pick aisle between the respective picking bays is preferably substantially clear to permit operators to move from one side of the pick aisle to another side of the pick aisle to pick or scan from both rows of picking bays.

Optionally and preferably, a trash system 90 is provided in the picking aisle so that when, for example, a box of products is emptied, the box may be deposited in the trash system for disposal. In the illustrated embodiment, trash system 90 includes a conveyor 92, which is positioned below the floor surface of the warehouse, or the like, in which the pick-to-light system 10 is installed. Access openings 94 are provided to permit trash to be deposited on the trash conveyor 92, which removes the trash and delivers trash to a trash discharge location 96. Preferably, trash conveyor apertures 94 are at least partially enclosed by a chute to prevent persons from falling onto the trash conveyor system.

In order to further enhance pick-to-light system 10, control system 12, preferably includes information about each product to be picked. For example, control system 12 may include information relating to the volume of the product so that control system 12 can determine how many pieces of a given product can be fit into a particular tote. Although totes 14 are illustrated as having the same dimensions, it should be understood that the size of the totes may be varied, though uniform sizing is preferred. In addition, control system 12 may organize products of an order into groups and associate the groups with totes. As noted above, control system 12 directs operators to pick and place products into a designated tote, preferably a designated tote of a group of totes. Furthermore, the picking bays may be organized by family groups of products so that one family group of products is in one row of picking bays or on one side of the picking aisle and potentially another family group of products is located in another row or on another side of the aisle. In this manner, the system may be adapted to fill totes by family groups. Some stores may wish to have delivered totes that include products grouped by how the products are grouped in the store's aisles.

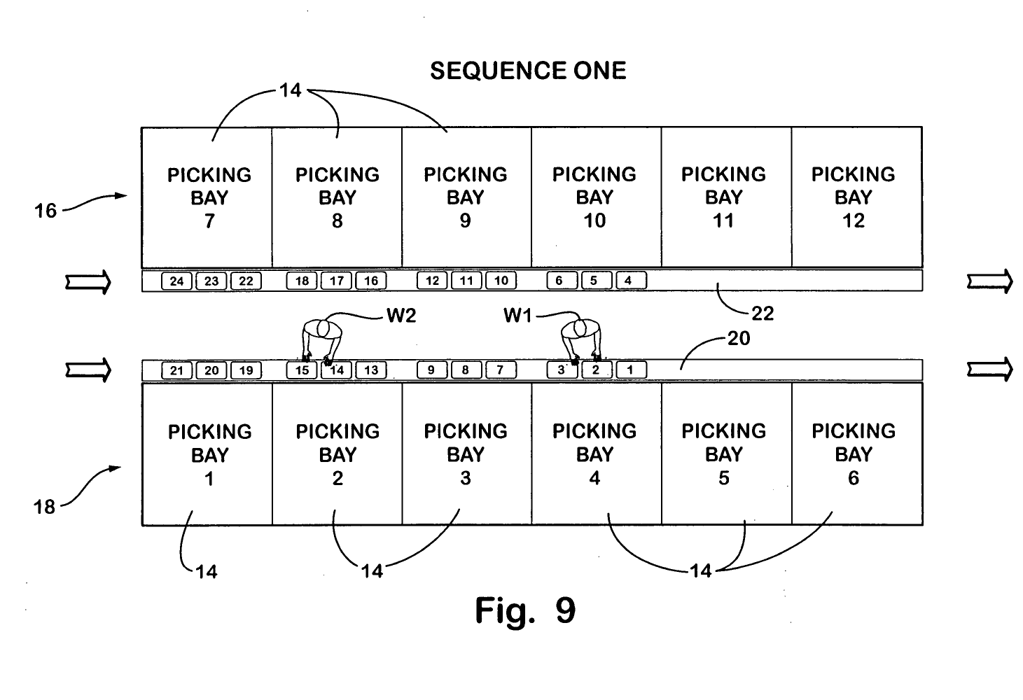

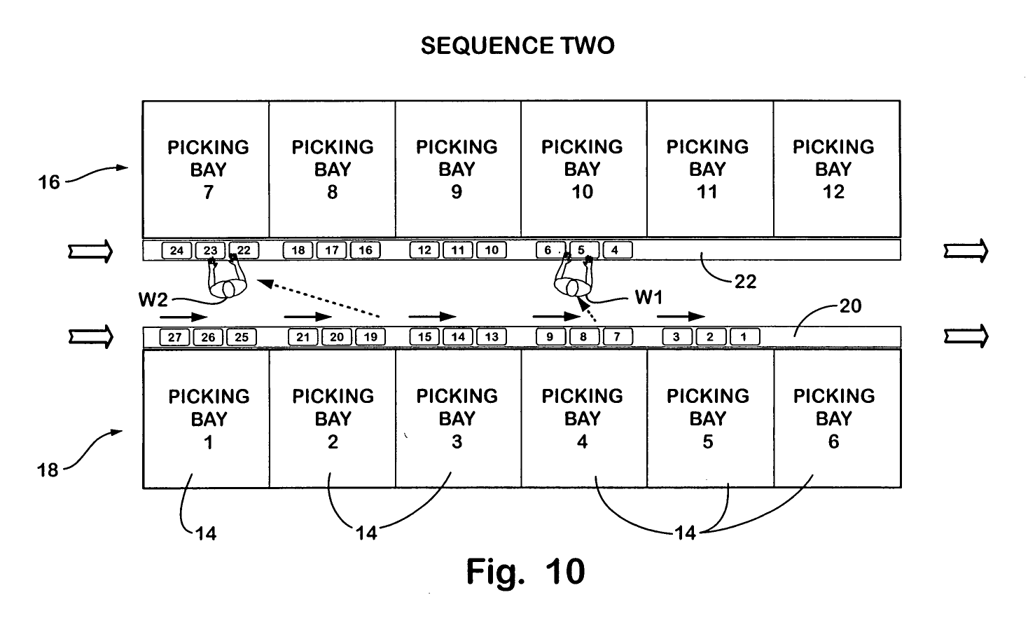

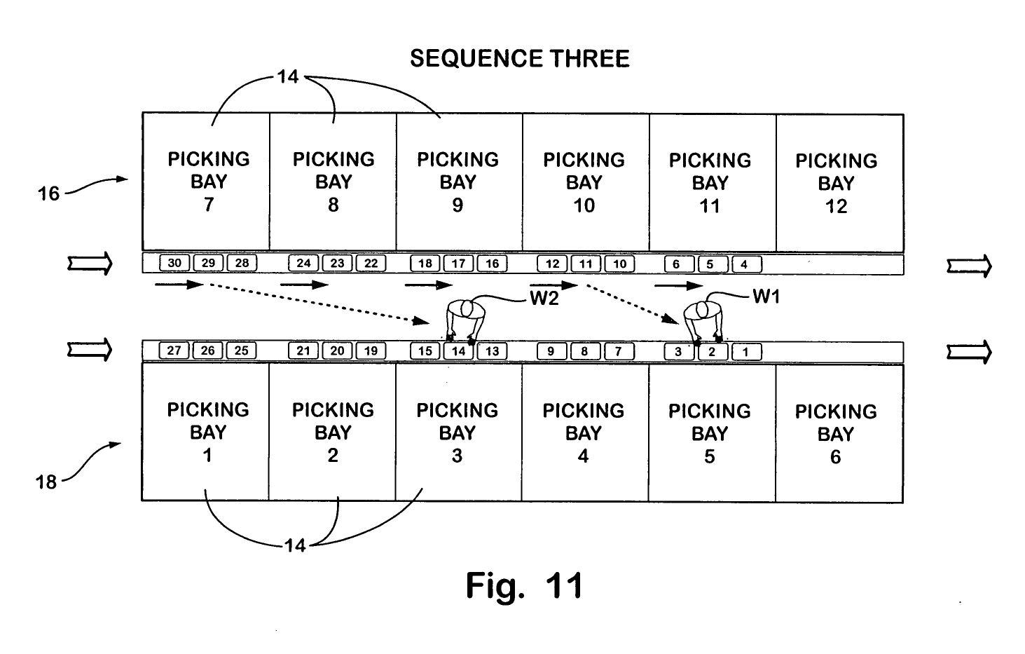

Referring to FIGS. 9-16, it should be understood, in operation, when a first group of totes is delivered by one of the conveyors, the first group of totes is initially aligned with a picking bay in one of the rows. Similarly, when a first group of totes in the other row is delivered, it is aligned with a picking bay in that row. In the illustrated embodiment, the first group of totes (totes 1, 2, 3) in aisle 18 is initially aligned with picking bay number 4 in the first row, and the first group of totes (totes 4,5,6) in the other row is aligned with picking bay number 10 in that row. It should be understood that the first groups of totes can be aligned with any of the picking bays, depending on where the orders for those totes are located.

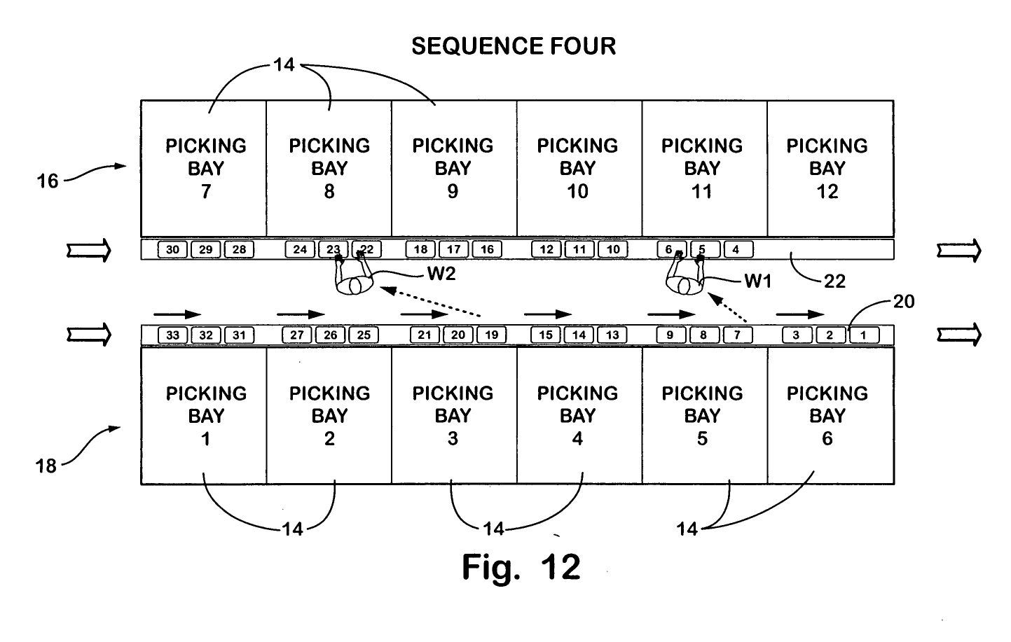

Referring to FIG. 9, after the products are picked for the designated totes in the first group of totes (totes 1, 2, 3) by operator worker W1 and the pick has been complete for the upstream totes, such as the third group of totes (totes 13, 14, and 15) by worker W2, all of the totes in aisle 18 will be indexed along conveyor 20 to align with the next selected picking bay in aisle 18. In this example, the first group of totes will then be aligned with picking bay number 5 in aisle 18, with the upstream groups of totes (totes 7, 8, 9; totes 13, 14, 15; totes 19, 20, 21; and totes 25, 26, 27) aligned with the respective upstream picking bays, namely picking bay numbers 4, 3, 2, and 1, respectively. While the totes conveyed on conveyor 20 are indexed, the operator W1 may move across the aisle to the other side of the aisle to aisle 16 to pick for a group of totes, for example, the first group of totes (totes 4, 5, 6) in the aisle 16, which is aligned with picking bay number 10. Similarly, the upstream worker W2 may cross the aisle to pick from, for example, the fourth group of totes in the aisle 16 (totes 22, 23, 24). After completing their respective picks in aisle 16, which may include picks for the adjacent groups of totes (such as totes 16, 17, 18, and/or 10, 11, 12) worker W1 may cross the aisle to aisle 18 once again to pick for the first group of totes (1, 2, 3) at picking bay number 5 and worker W2 may cross the aisle to pick for the third group of totes (13, 14, 15) at picking bay number 3. After both workers have completed their picks for aisle 16, the groups of totes (totes 4, 5, 6; totes 10, 11, 12; totes 16, 17, 18; and totes 22, 23, 24) supported on conveyor 22 are indexed to the next picking bay. Similarly, after completing the pick for the first and third groups of totes in aisle 18, workers W1 and W2 may transfer again across to aisle 16 to pick for the first and fourth group of totes in aisle 16 aligned with, for example, picking bay 11 and picking bay 8, respectively (FIG. 12). This process continues and permits the workers to work at their own speed and independent of each other and, further, in a manner that does not limit the speed of other workers. It can be appreciated that the workers in effect pick in parallel rather than in series as is done in conventional pick-to-light systems

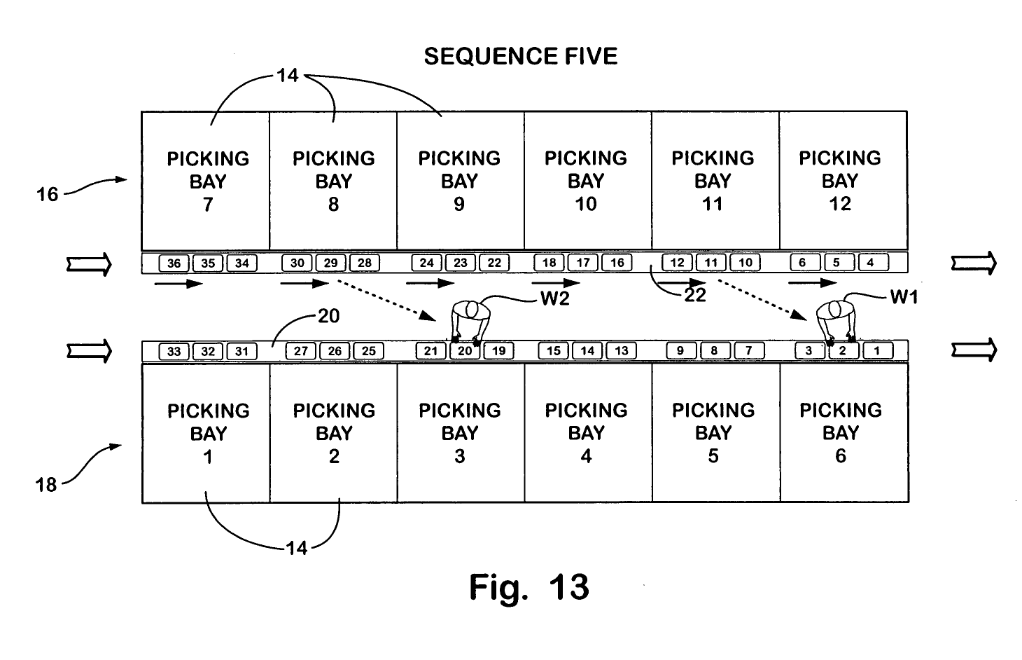

Referring to FIG. 13, after completing the pick for the first group of totes in the aisle 16 at picking bay 11, worker W1 can return to aisle 18 to pick for the first group of totes (totes 1, 2, 3) at picking bay 6 where the first group was indexed after the pick was completed for all the group of totes on conveyor 20. Similarly, after worker W2 has completed his or her pick in aisle 16, worker W2 may return to aisle 18 to pick, for example, the fourth group of totes (totes 19, 20, 21) at picking bay 3. As the process illustrates, each group of totes is not necessarily picked for each picking bay and may, in fact, be indexed through one or more bays before a pick is required.

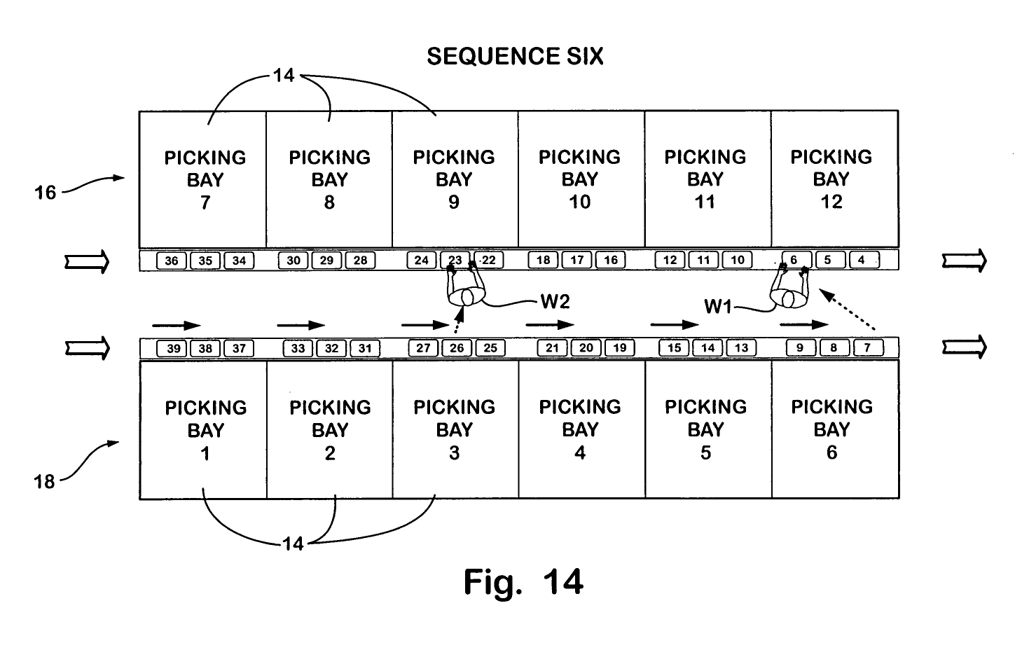

Referring to FIG. 14, after both workers W1 and W2 have completed their picks for the first group of totes at picking bay 6 and fourth group of totes at picking bay number 3, conveyor 20 indexes the groups of totes such that the second group of totes is aligned with picking bay number 6 and the third group of totes is aligned with picking bay number 4. In the meantime, worker W1 can switch, for example, to the other aisle to pick in aisle 16 and to pick for the first group of totes (totes 4, 5, 6) which are now aligned with picking bay number 12. Similarly, worker W2 may switch from picking bay number 3 from aisle 18 to aisle 16 to pick at picking bay number 9 to pick for the fourth group of totes (totes 22, 23, 24). In the illustrated embodiment, picking bay numbers 6 and 12 represent the last picking bays in the respective rows. It should be understood however, the number of picking bays may be increased or decreased as desired.

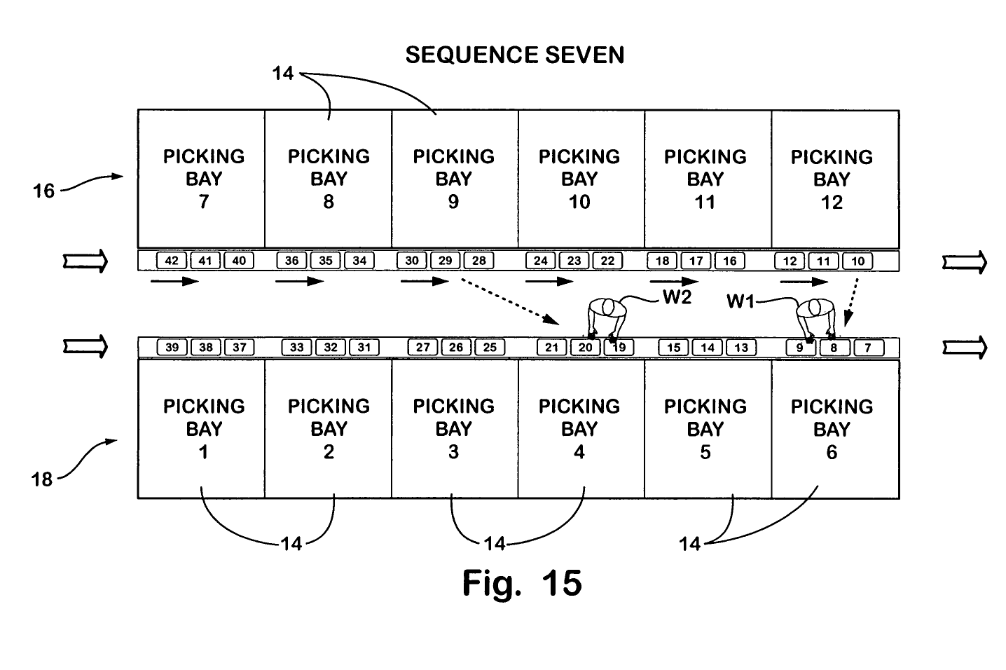

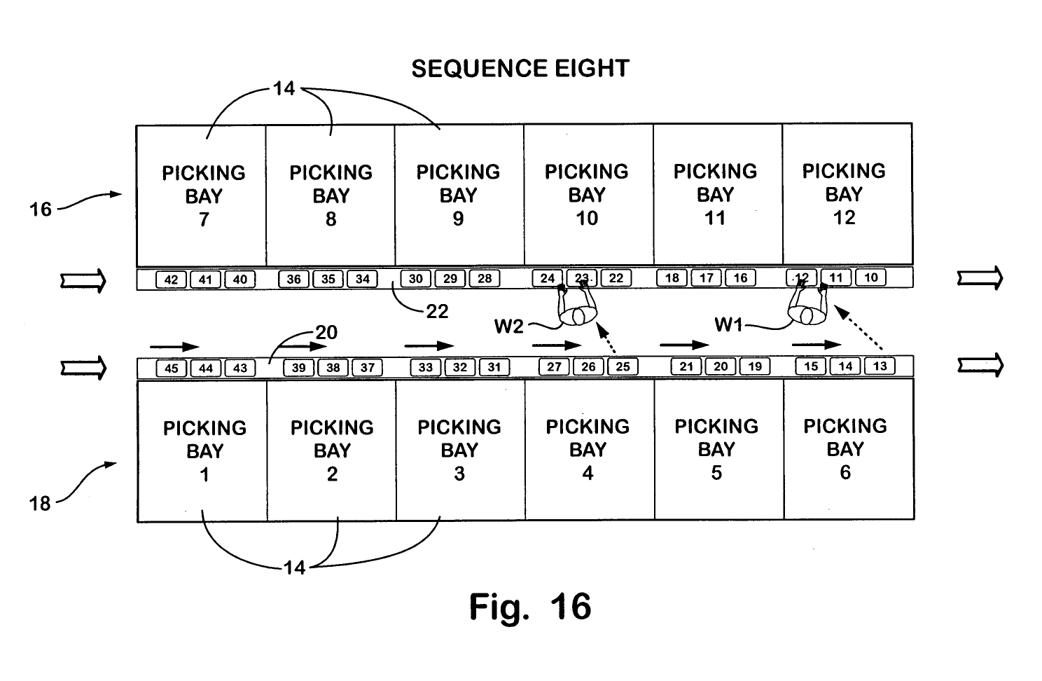

Referring to FIG. 15, worker W1 returns to aisle 18 to pick from the second group of totes (totes 7, 8, 9) at picking bay number 6. After worker W2 completes the pick at picking bay number 9 of the fourth group of totes (totes 28, 29, 30), worker W2 returns to aisle 18 to pick at the fourth group of totes (totes 19, 20, 21) in aisle 18, which are now positioned in front of picking bay number 4. Upon completion of the pick of the first and fourth groups of totes in aisle 16, conveyor 22 indexes the totes to align the fourth group of totes (totes 22, 23, 24) with picking bay 10 and the first group of totes (totes 4, 5, 6) are conveyed from pick-to-light system 10 as outbound totes. As will be understood, referring to FIG. 16, after each worker W1, W2 finishes their respective picks on the second group of totes (totes 7, 8, 9) and/or on the fourth groups of totes (totes 19, 20, 21) aisle 18, the workers then can switch to aisle 16 to pick, for example for the second group of totes and the fourth group of totes, respectively, at picking bays 12 and 10, respectively. This process can be repeated. Furthermore, it should be understood the workers are free to pick for more than one group of totes at a time. The sequence and selections of totes will vary depending on the speed of the respective workers and also the location of the products for the respective totes.

In addition, it can be appreciated that the present pick-to-light system eliminates the need for zones and, therefore, provides an increase in flexibility over conventional pick-to-light systems where operators are assigned and limited to a picking zone. From the foregoing, it should be appreciated that pick-to-light system 10 allows operators to manually pick products in a substantially continuous manner so that operators can work to their full capacity to reduce the inefficiencies of the pick systems heretofore known.

While several forms of the invention have been shown and described, other forms will now be apparent to those skilled in the art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. A method of picking products in a pick-to-light system, said method comprising:
arranging products in first and second rows of adjacent picking locations wherein the products are available for picking;
aligning groups of totes with the picking locations;
indicating a given tote in the group of totes;
indicating products to be picked for the given tote;
picking and placing the indicated products in the given tote; and
indexing a first group of totes from one of the picking locations to another picking location in one of the first and second rows when the indicated products are picked for each given tote in the first group of totes.

2. The method according to claim 1, wherein said aligning groups of totes comprising supporting said groups of totes on conveyors.

3. The method according to claim 2, wherein said indexing includes automatically driving a selected conveyor of said conveyors, said selected conveyor supporting said first group of totes.

4. The method according to claim 1, wherein said arranging products comprises supporting products on flow racks, said flow racks each having a product induct side and a product discharge side, said product discharge sides arranged at said picking locations wherein the products flow from said induct sides to said discharge sides to said picking locations.

5. The method according to claim 1, wherein said indicating comprises providing lights at each of said picking locations associated with each type of product and actuating at least one of said lights to indicate when a product associated with said at least one light is to be picked for the given tote.

6. The method according to claim 1, wherein said indicating comprises providing a designated light at each of said picking locations for each type of product and actuating said designated light when a product is to be picked for the given tote.

7. The method according to claim 1, wherein indicating a given tote comprises providing an indicator for each tote and actuating said indicator to indicate a given tote.

8. The method according to claim 7, wherein said providing an indicator comprises providing a light.

9. The method according to claim 7, wherein said providing an indicator comprises providing a light at said picking locations.

10. The method according to claim 1, wherein said aligning comprises aligning a group of totes with a respective picking location.

11. The method according to claim 10, further comprising indexing group of totes when the identified products have been picked and placed in each given tote of the groups of totes.

12. A method of picking products in a pick-to-light system, said method comprising:
providing products in a first row of picking bays, each of the picking bays having an induct side and a discharge side;
providing products in a second row of picking bays spaced from the first row of picking bays, each of the picking bays of the second row having an induct side and a discharge side;
forming an aisle between the discharge sides of the first and second rows of picking bays;
providing access across the aisle to an operator wherein the operator may move between the discharge sides of the first and second rows of picking bays;
aligning a first group of totes with the discharge side of an upstream picking bay in the first row;
aligning a second group of totes with the discharge side of an upstream picking bay in the second row;
indicating a product or products in the upstream picking bay of the first row to be picked by the operator for a tote in the first group of totes;
indicating a product or products in the upstream picking bay of the second row to be picked by the operator for a tote in the second group of totes; and
indexing a respective group of totes of said first and second groups of totes to a downstream picking bay in its respective row when the indicated product or products have been picked and placed by the operator wherein the operator may continue to pick at another picking bay.

13. The method according to claim 11, further comprising indicating a product or products in the downstream picking bay to be picked by the operator for the respective group of totes after the respective group of totes is indexed to the downstream picking bay; and indicating a product to be picked by an operator at the upstream picking bay of the respective row for a third group of totes.

14. The method according to claim 13, further comprising indexing the respective group of totes and the third group of totes wherein said respective group of totes aligns with a discharge side of a second downstream picking bay of the respective row and the third group of totes aligns with the discharge side of the first downstream picking bay of the respective row when the picking is complete for both the respective group of totes and the third group of totes.

15. The method according to claim 12, wherein said aligning the first and second groups of totes comprises supporting said groups of totes on first and second conveyors, respectively, adjacent the discharge sides of said picking bays of said first and second rows of picking bays, respectively, and said indexing includes automatically driving a respective conveyor of said conveyors which supports the respective group of totes to thereby index the respective group of totes.

16. The method according to claim 12, wherein said providing products comprises supporting products on flow racks, said products flowing from said induct sides to said discharge sides.

17. The method according to claim 12, wherein said indicating comprises providing lights associated with the products, and said indicating further comprises actuating a light to indicate when a product is to be picked.

18. The method according to claim 17, wherein said indicating comprises providing a light at each of said picking locations for each type of product and actuating a respective light of said lights when a product associated with said respective light is to be picked.

19. The method according to claim 12, wherein said providing a first group of totes comprises providing a first group of three totes.

20. The method according to claim 14, wherein said indexing further comprises providing a control system and controlling said indicating with the control system.

21. The method according to claim 20, wherein said indexing comprises driving the conveyors with the control system.

22. The method according to claim 21, further comprising detecting when an indicated product has been picked for a given tote with the control system.

23. The method according to claim 22, wherein said detecting includes a providing an actuator and detecting when said actuator has been actuated to detect when an indicated product has been picked for a given tote.

24. A pick-to-light system comprising:
means for supporting products in first and second rows and for grouping the products in a plurality of picking locations;
means for aligning a first group of totes adjacent an upstream picking location in said first row;
means for aligning a second group of totes adjacent an upstream picking location in said second row;
means for identifying each tote within said group of totes;
means for indicating which products are to be picked for and placed in a given tote of the group of totes at said first picking locations;
means for indexing said second group of totes from said upstream picking location in said second row;
means for indexing said first group of totes from said upstream picking location in said first row; and
a control system for actuating a respective means of said means for indexing when the products for a respective picking location are picked.

25. The pick-to-light system according to claim 24, wherein said means for supporting comprises a plurality of racks.

26. The pick-to-light system according to claim 25, wherein said racks comprise flow racks, with each rack having an induct side and discharge side, said means for aligning being adjacent said discharge sides of said flow racks.

27. The pick-to-light system according to claim 24, wherein said means for aligning said first group of said totes and said means for aligning said second group of totes comprise first and second conveyors, respectively.

28. The pick-to-light system according to claim 24, wherein said means for indexing comprises selectively driven conveyors.

29. The pick-to-light system according to claim 24, wherein said means for indicating comprises lights, said control system selectively actuating said lights.

30. A pick-to-light system comprising:
a plurality of racks supporting groups of products in first and second rows of adjacent picking locations;
a plurality of totes;
a first conveyor for supporting a first group of said totes adjacent a first picking location of said first row;
a second conveyor for supporting a second group of said totes adjacent a first picking location of said second row;
a control system for identifying selected products to be picked for a given tote and detecting when the selected products are picked for the given tote, and said control system actuating said first conveyor to index said first groups of totes to another picking location in said first row when the selected products of the first picking location in said first row have been picked and placed in each given tote of said first groups of totes and actuating said second conveyor to index said second groups of totes to another picking location in said second row when the selected products of the first picking location in the second row have been picked and placed in each of the given totes of said second group of totes.

31. The pick-to-light system according to claim 30, wherein said racks comprise flow racks, with each rack having an induct side and discharge side, said discharge sides comprising said picking locations.

32. The pick-to-light system according to claim 30, wherein said control system includes indicators, said indicators identifying the selected products.

33. The pick-to-light system according to claim 32, wherein said indicators include lights for identifying the selected products.

34. The pick-to-light system according to claim 33, wherein said indicators include displays for identifying the given tote.

35. The pick-to-light system according to claim 34, wherein each of said totes includes an identifier, said displays for displaying said identifiers.

36. The pick-to-light system according to claim 32, wherein each of said totes includes an indicator associate therewith for identifying the given tote.

37. The pick-to-light system according to claim 35, wherein said indicators are provided at said picking locations.

38. The pick-to-light system according to claim 36, wherein said indicators are provided at said conveyors.

39. The pick-to-light system according to claim 32, wherein said indicators display a mode of operation for said pick-to-light system.

40. The pick-to-light system according to claim 30, further comprising operator actuated devices for indicating when a selected product is picked for a given tote, said control system detecting when said operator actuated devices are actuated to determine when the selected product is picked for the given tote.

41. A method of picking products in a pick-to-light system, said method comprising:
providing products in a first row of picking bays, each of the picking bays having an induct side and a discharge side;
providing products in a second row of picking bays spaced from the first row of picking bays, each of the picking bays of the second row having an induct side and a discharge side;
forming an aisle between the discharge sides of the first and second rows of picking bays;
providing access across the aisle to an operator wherein the operator may move between the discharge sides of the first and second rows of picking bays;
aligning a first tote with the discharge side of a first picking bay in the first row;
aligning a second tote with the discharge side of a first picking bay in the second row;
indicating a product or products in the first picking bay of the first row to be picked by the operator for the first tote;
indicating a product or products in the first picking bay of the second row to be picked by the operator for the second tote; and
indexing a respective tote of the first and second totes to a second picking bay in a respective row of the first and second rows when the indicated product or products have been picked and placed in the respective tote by the operator wherein the operator may continue to pick at another picking bay.

42. The method according to claim 41, further comprising indicating a product or products in the second picking bay to be picked by the operator for the respective tote after the respective tote is indexed to the second picking bay; and indicating a product to be picked by an operator at the first picking bay of the respective row for a third tote.

43. The method according to claim 42, further comprising indexing the respective tote and the third tote wherein said respective totes aligns with a discharge side of a third picking bay of the respective row and the third tote aligns with the discharge side of the second picking bay of the respective row when the picking is complete for both the respective tote and the third tote.

44. The method according to claim 41, wherein said aligning a first tote and said aligning a second tote comprises supporting said first and second totes on first and second conveyors, respectively, adjacent the discharge sides of said picking bays of said first and second rows of picking bays, respectively, and said indexing includes selectively driving a respective conveyor of said conveyors which supports the respective tote to thereby index the respective tote.

45. The method according to claim 44, wherein said providing products comprises supporting products on flow racks, said products flowing from said induct sides to said discharge sides.

46. The method according to claim 45, wherein said indicating comprises providing lights associated with the products, and said indicating further comprises actuating a light to indicate when a product is to be picked.

47. The method according to claim 46, wherein said indicating comprises providing a light at each of said picking locations for each type of product and actuating a respective light of said lights when a product associated with said respective light is to be picked.

48. The method according to claim 44, wherein said providing a plurality of totes comprises providing groups of totes, and said aligning comprises aligning a first group of totes of said group of totes adjacent the discharge side of the first row of picking bays and align a second group of totes of said group of totes adjacent the discharge side of the second row of picking bay.

49. The method according to claim 48, wherein said indexing a respective tote comprises indexing a respective group of totes after the indicated products or products for each of the totes in the respective group of totes have been picked.

50. The method according to claim 41, wherein said indexing further comprises providing a control system and controlling said indicating with said control system.

51. The method according to claim 50, further comprising detecting when an indicated product has been picked for a given tote with the control system.

52. The method according to claim 51, wherein said detecting includes a providing an actuator and detecting when said actuator has been actuated to detect when an indicated product has been picked for a given tote.
